(19) United States
(12) Patent Application Publication
(10) Pub. No.: US 2026/0359700 A1
(43) Pub. Date: Nov. 12, 2026

(54) Resilient Switchover Annealer System

(71) Applicant: Bank of America Corporation, Charlotte, NC (US)

(72) Inventors: Saurabh Arora, New Palam Vihar, Gurugram (IN); Sandeep Chauhan, Hyderabad (IN); Jhalak Khurana, Haryana (IN); Anil Gajula, Hyderabad (IN)

(73) Assignee: Bank of America Corporation, Charlotte, NC (US)

(21) Appl. No.: 18/592,267

(22) Filed: Feb. 29, 2024

(51) Int. Cl. G06N 10/60; G06N 10/40; G06N 10/70

(52) U.S. Cl. CPC G06N 10/60; G06N 10/40; G06N 10/70

(57) ABSTRACT

Various aspects of the disclosure relate to automated protection against loss of critical data in quantum computing systems. A resilient switchover annealer system monitors quantum data status for critical data and maintains a real-time protected copy in a separate and secure location, such as in a cloud computing network. A switchover annealer changes network paths dynamically between classical computing devices and quantum processing nodes, where the same common critical data is available for each different (classical or quantum) computing path as needed. A real-time data monitor monitors quantum data for indicia of quantum data loss and monitors network path validation and processing operations. The switchover annealer may identify critical data loss and performs switching of processing actions from quantum to classical computing systems upon identified data loss conditions.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly manage how internal computer systems exchange information with external computer systems in providing and/or supporting different products and services offered by the organization. For example, financial applications and/or other data critical applications rely on the quality of data and enhanced processing capabilities. As such, these data critical applications often leverage quantum computing as a service to process and run highly data intensive and/or time critical models in real time. Because these data critical functions and/or the increased processing powers rely on object states and/or other critical data being stored in quantum memory for long durations of time. A common problem with current quantum computing environments is that quantum memory is subject to data loss due to decoherence issues. These decoherence issues lead to state loss and data loss through network paths, causing the quantum computing functions to fail and/or to provide incorrect information.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes monitoring quantum computing functionalities and/or a status of quantum memory, backing up critical information stored in quantum memory and automatically recovering lost data and/or switching to alternate classical computing functionality to ensure critical applications complete as expected.

Aspects of the disclosure relate to computer hardware and software. In particular, one or more aspects of the disclosure generally relate to resilient switchover annealers with state storage for critical functions to recover from potential quantum data loss from stored object states and through network paths with a controlled switch to enable alternate functional computing systems and processes.

Applications planned to leverage quantum computing as a service (QaaS) or other quantum computing functionalities often have no direct control of the quantum computing system to reduce a possibility of data loss. As such, a need has been recognized for observer engines to automatically monitor data stored in quantum memory, such as object states, via a real-time processing path over the quantum network. Additionally, a mechanism is needed to identify a processing path criticality for each memory module, often as compared to the process being performed via classical computing functionality. Due to the lack of control of quantum processors and the quantum memory, a hybrid approach is used to form a mechanism to recover, or avoid, quantum data loss. A switchover annealer system may change network paths dynamically between classical computing devices and quantum processing nodes, where common critical data is available for each different (classical or quantum) computing path. In doing so, the hybrid system consecutively leverages cross computing system memory instances, where processing is performed separately. Here, the common memory (e.g., cloud computing data storage) may provide a state store that enables transition through hybrid state management for recovery across the different computing paths. To accomplish this functionality, enterprise networks may leverage powerful computing capabilities (e.g., quantum computing services) with enterprise focused methods that ensure critical applications are resilient to faults and/or data loss occurring due to interference of quantum states due to quantum decoherence. The enterprise methodologies may provide a path to route critical functions subject to a high likelihood of quantum data loss to classical computing devices while linking common memory storage with associated data connections.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for resilient switchover between quantum computing and classical computing due to potential quantum data loss, in accordance with one or more aspects described herein;

FIG. 1B shows an illustrative computing platform enabled for resilient switchover between quantum computing and classical computing due to potential quantum data loss, in accordance with one or more aspects described herein; and

FIG. 2 shows an illustrative block diagram of a systems for resilient switchover between quantum computing and classical computing due to potential quantum data loss in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

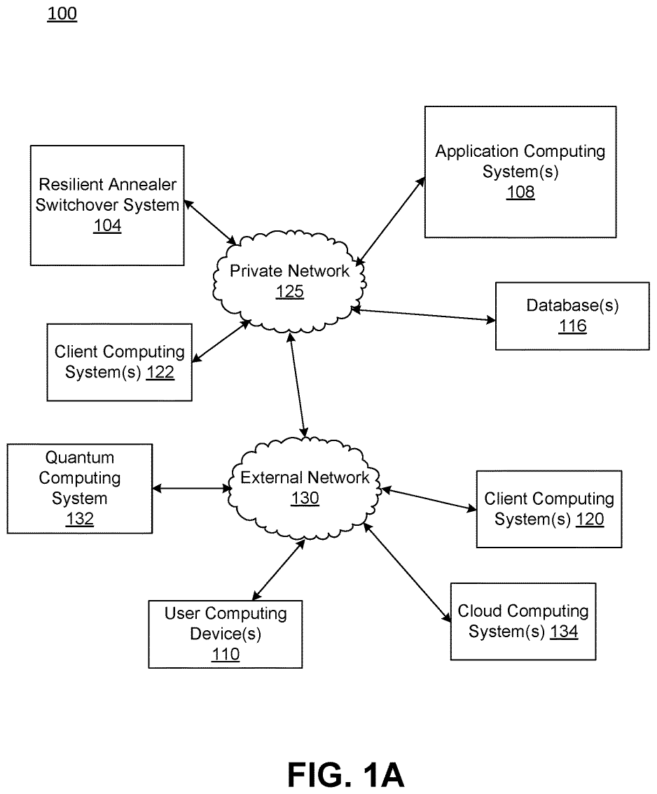

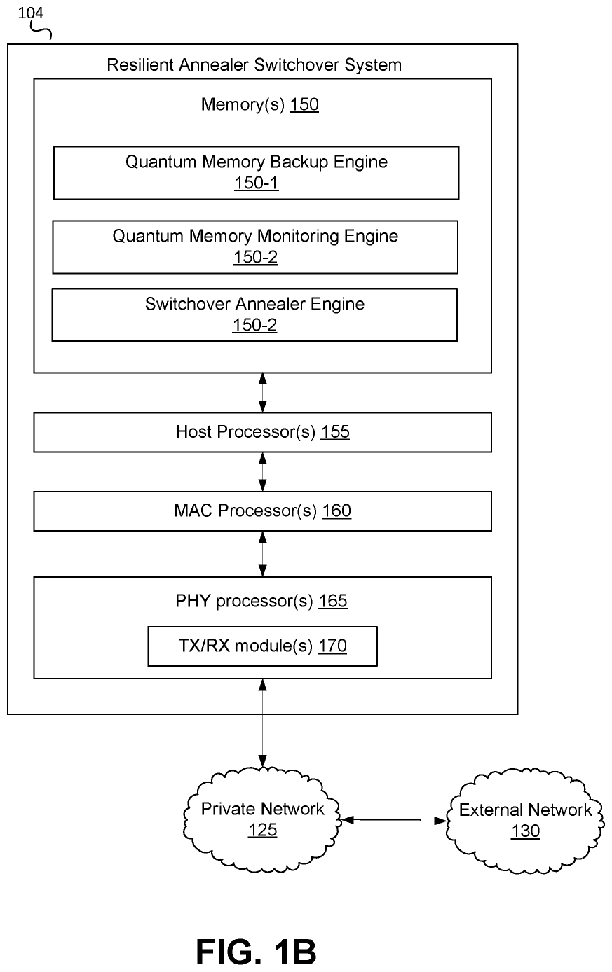

FIG. 1A shows an illustrative computing environment 100 for resilient switchover between quantum computing and classical computing due to potential quantum data loss, in accordance with one or more arrangements. The computing environment 100 may comprise one or more devices (e.g., computer systems, communication devices, and the like). The computing environment 100 may comprise, for example, a resilient annealer switchover system 104, one or more application computing systems 108, one or more client computing systems 122, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing systems 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the resilient annealer switchover system 104 as being a separate computing system, the resilient annealer switchover system 104 may be implemented as a part of one or more computing systems, such as the application computing systems 108.

The resilient annealer switchover system 104 may comprise one or more computing devices and/or other computer components (e.g., processors, memories, communication interfaces) configured to perform one or more functions as described herein. Further details associated with the architecture of the resilient annealer switchover system 104 are described with reference to FIG. 1B.

The application computing systems 108 and/or the client computing systems 122 may comprise one or more computing devices and/or other computer components (e.g., processors, memories, communication interfaces). In addition, the application computing systems 108 and/or the client computing systems 122 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing systems 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing systems 122 and/or the application computing systems 108 may comprise various servers and/or databases that store and/or otherwise maintain account information, such as financial account information including account balances, transaction history, account owner information, and/or other information. In addition, the client computing systems 122 and/or the application computing systems 108 may process and/or otherwise execute transactions on specific accounts based on commands and/or other information received from other computer systems comprising the computing environment 100. In some cases, one or more of the client computing systems 122 and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing systems 120 may comprise one or more computing devices and/or other computer components (e.g., processors, memories, communication interfaces). The client computing systems 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 120 is for processing an electronic exchange of goods and/or services. The client computing systems 120 may be associated with a specific goods purchasing activity, such as purchasing a vehicle, transferring title of real estate may perform communicate with one or more other platforms within the client computing systems 120. In some cases, the client computing systems 120 may integrate API calls to request data, initiate functionality, or otherwise communicate with the one or more application computing systems 108, such as via the services. For example, the services may be configured to facilitate data communications (e.g., data gathering functions, data writing functions, and the like) between the client computing systems 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the resilient annealer switchover system 104. For example, the database(s) 116 may store memory thresholds, memory routing information, links to cloud memory, cloud memory storage, and the like. In an arrangement, the database(s) 116 may be used for other purposes as described herein. In some cases, the client computing systems 120 may write data or read data to the database(s) 116 via the services. The quantum computing system 132 may be enterprise owned and/or provided by a third-party, such as a quantum as a service interface. The cloud computing system 134 may be enterprise owned and/or provided by a third-party, such as a cloud memory storage as a service interface.

In one or more arrangements, the resilient annealer switchover system 104, the application computing systems 108, the client computing systems 122, the client computing systems 120, the user devices 110, and/or the other devices/systems in the computing environment 100 may be any type of computing device capable of receiving input via a user interface, and communicating the received input to one or more other computing devices in the computing environment 100. For example, the resilient annealer switchover system 104, the Resilient annealer switchover system 104, the application computing systems 108, the client computing systems 122, the user the client computing systems 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the resilient annealer switchover system 104, the Resilient annealer switchover system 104, the application computing systems 108, the client computing systems 122, the user the client computing systems 120, the user devices 110, and/or the other devices/systems in the computing environment 100 may, in some instances, be and/or comprise special-purpose computing devices configured to perform specific functions.

FIG. 1B shows an illustrative resilient annealer switchover system 104 in accordance with one or more examples described herein. The resilient annealer switchover system 104 may be a stand-alone device and/or may at least be partial integrated with the resilient annealer switchover system 104may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The resilient annealer switchover system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the resilient annealer switchover system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the resilient annealer switchover system 104 may be configured to execute machine readable instructions stored in memory 150. The memory 150 may comprise (i) one or more program modules/engines having instructions that when executed by the one or more processors cause the resilient annealer switchover system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the resilient annealer switchover system 104 and/or by different computing devices that may form and/or otherwise make up the resilient annealer switchover system 104. For example, the memory 150 may have, store, and/or comprise a quantum memory backup engine 150-1, a quantum memory monitoring engine 150-2, a switchover annealer engine 150-3 and/or the like. The quantum memory backup engine 150-1 may have instructions that direct and/or cause the resilient annealer switchover system 104 to perform one or more operations associated with reliably backing up critical quantum data to an accessible, but secure, memory location, such as a secure cloud storage system, and the like. The quantum memory monitoring engine 150-2 may have instructions that may cause the resilient annealer switchover system 104 to monitor stability and/or reliability of quantum memory. The switchover annealer engine 150-3 may analyze information provided by the quantum memory monitoring engine 150-2 and the quantum memory backup engine 150-1 to identify conditions requiring switchover from using quantum computing services to a classical computing service to ensure data continuity and ensuring correct backup secure data is used accordingly.

While FIG. 1A illustrates the resilient annealer switchover system 104, the resilient annealer switchover system 104, and/or the application computing systems 108, as being separate elements connected in the private network 125, in one or more other arrangements, functions of one or more of the above may be integrated in a single device/network of devices. For example, elements in the resilient annealer switchover system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the resilient annealer switchover system 104, and/or the application computing systems 108.

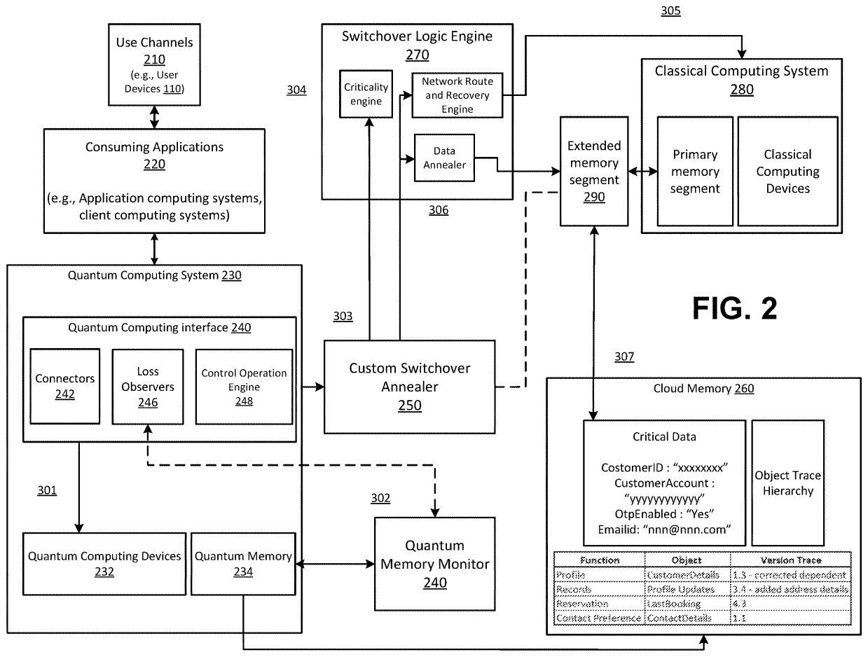

FIG. 2 shows an illustrative block diagram of a systems for resilient switchover between quantum computing and classical computing due to potential quantum data loss in accordance with one or more aspects described herein. For example, FIG. 2 shows automated protection against loss of critical data in quantum computing systems. A resilient switchover annealer system monitors quantum data status for critical data and maintains a real-time protected copy in a separate and secure location, such as in a cloud computing network. A switchover annealer changes network paths dynamically between classical computing devices and quantum processing nodes, where the same common critical data is available for each different (classical or quantum) computing path as needed. A real-time data monitor monitors quantum data for indicia of quantum data loss and monitors network path validation and processing operations. The switchover annealer may identify critical data loss and performs switching of processing actions from quantum to classical computing systems upon identified data loss conditions.

A customized switchover annealer may enable transition to and from quantum processing of data and processing certain segments of data via classical computing systems separately to ensure seamless and automatic recovery from unexpected quantum data loss in memory or with a lost network path. FIG. 2 shows a quantum computing enabled system where requests may be sent from a variety of user channels 210, such as a user device (e.g., a smart device, a personal computer, and the like) to request an action to be performed by one or more data consuming applications 220 (e.g., the one or more application computing systems 108, the client computing systems 120, 122, and/or the like). In some cases, the data consuming applications 220 may request certain functionality to be performed by a quantum computing system 230, such as to improve a computation speed and/or efficiency such that a requested action (e.g., a transaction request, a securities trade request, and the like). To perform the requested calculations, the quantum computing system 230 may receive the computational request (e.g., quantum code snippets, quantum programs, and/or the like, and data to be processed by the quantum code snippets and/or quantum programs) via a quantum computing interface 240, such as via connectors 242. The connectors 242 may facilitate transfer of information (e.g., code, programs, data, and the like) between the requesting consuming applications 220 to the quantum memory 234 to be processed by the quantum computing devices 232.

At 301, the connection interface, such as the connectors 242, may provide a connection point to the enterprise computing system, such as via external ports, to route the consuming applications'traffic to quantum processing resources, such as the quantum memory 234 and the quantum computing devices 232. In some cases, the quantum computing system 230 may be leveraged as a service for regular transactions of critical modules that require high throughput and utilize quantum memory for object states. At 302, one or more loss observers 246 may monitor a status of the quantum memory 234 for indications of data loss across an object's quantum states from the quantum memory 234 and one or more of the loss observers 246 may monitor for data loss occurring through processing paths and/or network path validations caused by interference within the quantum computing system. For example, the loss observers 246 may monitor quantum processing connections to quantum memory to identify data loss across object states and loss through network paths. The connectors 242 and/or the control operation engine 248 may also copy critical information stored in the quantum memory 234 to a secure backup location, such as cloud memory 260 of a cloud computing system 134. The cloud memory 260 may store critical data, object trace hierarchy information, function processing information, object information, version trace information, and the like, where the stored information is necessary for the computations being performed by the quantum computing device 232 to complete the functionality requested from the consuming applications 220.

At 303, a control operation engine 248 may be triggered by one or more of the loss observers 246 based on an identified quantum data loss indicator and/or a processing or network path error (e.g., a decoherence indication) to initiate operation by the custom switch annealer 250 to identify quantum computing functionality that may need to be switched. At 304, the custom switchover annealer 250 may perform switchover logic 270 to identify a processed function's criticality with respect to loss observations from the loss observers 246. In some cases, the switchover logic 270 may further incorporate business rules and/or policies to further indicate a processing value (e.g., a business operation value) to generate a loss possibility score corresponding to whether data loss would lead to deviated outcomes or it is in threshold limits of deviation. For example, the loss possibility score may be measured against a loss threshold, when the threshold condition is met, the custom switchover annealer 250 may perform certain functionalities. For example, the custom switchover annealer may detail out switchover functionality to the switchover logic engine to identify data loss characteristics (e.g., criticality of information lost per drop percentage), where the criticality against loss observations and/or criticality against business value may be calculated as a weighted average of loss factors across the quantum memory objects when compared to an importance of the data and/or the network processing paths to critical functionality. For example, if the data loss relates to loss of critical data to perform the requested action (e.g., loss of client identifier information such as name, account number and/or the like) during a transaction processing event, the criticality may be high (e.g., a loss possibility score is 90/100) where loss of non-critical information (e.g., an unused variable of a data object otherwise used in a calculation) the criticality may be low (e.g., a loss possibility score of 15/100) and a threshold may be set at 70.

At 305, if the switchover logic engine 270 identifies a loss (e.g., a loss threshold condition has been met) while processing information and/or during data transfer, the custom switchover annealer 250 may initiate a network path switch to a classical computing system 280 to cause recover of critical modules. At 306, if a loss was identified in data segments (e.g., quantum memory), the custom switchover annealer 250 may route data read calls to extended memory segments via a state store where the state store is used as a bridge. In some cases, the extended memory segments may be additional quantum memory, classical memory, cloud memory, or a combination of different memory types. The extended memory segment 290 may synchronize with the cloud memory using memory dumps from temporary classical computing processing to the cloud-based state store for transitioning in and/or out of the quantum network. In doing so, the quantum memory 234 remains updated and synchronized with critical information, such that the quantum computing devices 232 may complete operations and override any possible quantum data loss issues, such as those encountered due to decoherence issues.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a switchover annealer system comprising
a first processor; and
first memory storing first instructions, that when executed by the first processor, cause the switchover annealer system to:
monitor memory operations of a quantum computing system for an indication of data loss;
communicate, via a network and to a network accessible data store, information stored in quantum memory of the quantum computing system;
determine, based on an identified indication of data loss, a criticality score associated with the indication of data loss; and
trigger, based on the criticality score meeting a threshold, a classical computing system to process data associated with the indication of data loss; and
the classical computing system comprising:
a second processor; and
second memory storing instructions that, when executed by the second processor, cause the classical computing system to:
retrieve, from the network accessible data store, data associated with the indication of data loss;
process the retrieved data; and
trigger, the quantum computing system, to receive the processed data via a network and continue processing information stored in quantum memory of the quantum computing system.

2. The system of claim 1, further comprising the quantum computing system comprising:
a quantum processor; and
the quantum memory storing instructions that, when executed by the quantum processor, cause the quantum computing system to:
receive, via a network, data from an application computing system;
store the received data in quantum memory; and
process, based on instructions received from the application computing system, the stored data; and
return, to the application computing system, results of the data being processed by the instructions.

3. The system of claim 2, wherein the instructions received from the application computing system comprise quantum code.

4. The system of claim 2, wherein the data received from the application computing system comprises operational data critical to the application computing system.

5. The system of claim 1, wherein the switchover annealer system is integrated into the quantum computing system.

6. The system of claim 1, wherein the network accessible data store comprises a cloud data storage system.

7. The system of claim 6, wherein the first instructions further cause the switchover annealer system to synchronize, in real-time, the quantum memory with the cloud data storage system.

8. A method comprising:
monitoring memory operations of a quantum computing system for an indication of data loss;
communicating, via a network and to a network accessible data store, information stored in quantum memory of the quantum computing system;
determining, by a switchover annealer system and based on an identified indication of data loss, a criticality score associated with the indication of data loss;
triggering, based on the criticality score meeting a threshold, a classical computing system to process data associated with the indication of data loss
retrieving, from the network accessible data store, data associated with the indication of data loss;
processing the retrieved data; and
triggering, the quantum computing system, to receive the processed data via a network and continue processing information stored in quantum memory of the quantum computing system.

9. The method of claim 8, further comprising:
receiving, via a network, data from an application computing system;
storing the received data in quantum memory; and
processing, based on instructions received from the application computing system, the stored data; and
returning, to the application computing system, results of the data being processed by the instructions.

10. The method of claim 9, wherein the instructions received from the application computing system comprise quantum code.

11. The method of claim 9, wherein the data received from the application computing system comprises critical operational data.

12. The method of claim 8, wherein the switchover annealer system is integrated into the quantum computing system.

13. The method of claim 8, wherein the network accessible data store comprises a cloud data storage system.

14. The method of claim 13, further comprising causing the switchover annealer system to synchronize, in real-time, the quantum memory with the cloud data storage system.

15. Non-transitory computer readable media storing instructions that, when executed by a processor, cause a switchover annealer system to:
monitor memory operations of a quantum computing system for an indication of data loss;
communicate, via a network and to a network accessible data store, information stored in quantum memory of the quantum computing system;
determine, based on an identified indication of data loss, a criticality score associated with the indication of data loss;
trigger, based on the criticality score meeting a threshold, a classical computing system to process data associated with the indication of data loss; and
trigger, the quantum computing system and from the classical computing system, to receive processed data via a network and continue processing information stored in quantum memory of the quantum computing system.

16. The non-transitory computer readable media of claim 15, wherein the switchover annealer system is integrated into the quantum computing system.

17. The non-transitory computer readable media of claim 16, wherein the instructions cause the quantum computing system to:
receive, via a network, data from an application computing system;
store the received data in quantum memory; and
process, based on instructions received from the application computing system, the stored data; and
return, to the application computing system, results of the data being processed by the instructions.

18. The non-transitory computer readable media of claim 17, wherein the instructions received from the application computing system comprise quantum code.

19. The non-transitory computer readable media of claim 17, wherein the data received from the application computing system comprises critical operational data.

20. The non-transitory computer readable media of claim 15, wherein the instructions further cause the switchover annealer system to synchronize, in real-time, the quantum memory with a cloud data storage system.
